(19) United States
(12) Patent Application Publication
(10) Pub. No.: US 2002/0040594 A1
(43) Pub. Date: Apr. 11, 2002

(54) Glide head with separated sensitive rail

(76) Inventors: Susumu Matsui, Mohka (JP); Takeshi Satoh, Utsunomiya (JP)

Correspondence Address: STAAS & HALSEY LLP, 700 11TH STREET, NW, SUITE 500, WASHINGTON, DC, 20001, US

(21) Appl. No.: 09/960,958

(22) Filed: Sep. 25, 2001

(30) Foreign Application Priority Data
Oct. 3, 2000 (JP) 2000-303692

(51) Int. Cl. G01N 19/02; B23Q 17/09

(52) U.S. Cl. 73/104; 360/236.3

(57) ABSTRACT

A glide head for inspecting an asperity, protrusion, or foreign material on a magnetic disk is disclosed. The glide head has a slider to be floated up to a predetermined height on the magnetic disk in accordance with the rotation of the disk. The slider has two substantially parallel rails protruding from the air-bearing surface of the slider and a sensitive rail protruding downward separately from the two substantially parallel rails. The two substantially parallel rails float the glide head and extend from the leading end of the slider toward the trailing end of it. The sensitive rail is located at the trailing end of the slider rather than trailing ends of the two substantially parallel rails. It is preferable that the area of the sensitive rail is the half of or less than the total area of the two substantially parallel rails. Because the gap between the slider and the magnetic disk is minimized at the trailing end of the sensitive rail, an asperity, protrusion, or contaminant on the magnetic disk is detected by the sensitive rail.

### BACKGROUND OF THE INVENTION

1. Field of the Invention

The present invention relates to a configuration of a glide head used for a magnetic-disk manufacturing and/or inspection and the like, particularly to a magnetic-disk glide head having a piezoelectric element for sensitively detecting micro asperities, protrusions, or contaminants equal to or exceeding a specified value present on the surface of a film-formed magnetic disk.

2. Description of Related Art

As well-known, a magnetic disk used for a hard disk drive is used as a recording medium of a magnetic memory constituted by forming a magnetic medium on the surface of a discoid non-magnetic substrate made of glass or aluminum to record or read information by a magnetic head. A process for manufacturing a magnetic disk is briefly described below. The surface of a substrate is smoothed and then, an underlayer, a magnetic film, and a protective layer are formed in order. When the processes for forming these films are completed, the surface of the magnetic disk is finished. This process is performed to secure the smoothness of the surface of the magnetic disk. Protrusions or asperities more than a specified value present on the surface of a magnetic disk would cause breakdown of data or abnormal abrasion of the air-bearing surface of a magnetic head or cause the CSS (contact start and stop) characteristic to extremely deteriorate. Therefore, the finishing process is an important process in order to secure the reliability.

A head having a special structure referred to as a burnishing head is used in the finishing process. The head has almost the same structure as a floating head and the structure is preferable to remove protrusions and the like because the air-bearing surface of a slider is formed into a special shape. By sliding the burnishing head over the entire surface of a magnetic head, unnecessary micro protrusions and dust are removed from the surface of a magnetic disk.

In the subsequent inspection process, it is measured whether a deformation degree of or the number of protrusions on the surface of a magnetic disk is kept in a range of the number and height specified in the specification to determine the quality of the magnetic disk. There are some magnetic-disk surface inspection methods. One of them is a method of measuring the surface state of a finished magnetic disk by a detection sensor while rotating the disk. Glide heads having various configurations are proposed and practically used. However, because a magnetic disk has been recently decreased in size and increased in recording density, a glide head having a piezoelectric element has been mainly used. This is because the glide head requires only a small setting space and has a high sensitivity.

FIG. 8 is an illustration for explaining the operation principle of a glide head. The slider 70 of the glide head is floated by the action of airflow according to rotation of a magnetic disk 80. When the rotation reaches a certain speed, the slider 70 floats on the magnetic disk 80 while keeping a predetermined flying height h. The airflow advances from the leading end 70a of the slider to the trailing end 70b of it along an air-bearing surface 71. When the slider 70 contacts or collides with a protrusion 81 on the disk, impulses propagate through the slider 70 to vibration-deform a piezoelectric element 72. By obtaining an electrical signal generated in the piezoelectric element 72 through a lead wire 73, it is possible to detect the protrusion. In FIG. 8, symbol 74 denotes a suspension. Moreover, by moving the slider 70 at the predetermined flying height h on the surface of the magnetic disk, the air-bearing surface 71 of the slider contacts (collides with) a protrusion or deformed portion (deformation) higher than the flying height h. By obtaining the impulse generated in this case and the location on the magnetic disk, it is possible to detect protrusions larger than spedified in the specification present on the surface of the magnetic disk.

Two rails are generally formed on the air-bearing surface of the glide head operating in accordance with the above principle. By using two rails, it is possible to stably keep a flying attitude. Moreover, in the case of a glide head having two rails, it is possible to comparatively easily control the flying height of the head by changing widths of the rails causing the floating force of the glide head and easily design a desired glide head in accordance with the specification of heights of asperities, protrusions, and contaminants. However, the glide head having two rails also has problems. While a magnetic disk rotates at a certain revolving speed, linear speed of the outer periphery is larger than that of the inner periphery. When a glide head having two rails of the same length and same width flies on a magnetic disk, the flying height of the outer-peripheral rail becomes larger than that of the inner-peripheral rail due to the difference in linear speed. The impulse caused by the outer-peripheral rail collisions with a protrusion of the magnetic disk becomes weaker than the impulse caused by the inner-peripheral rail collisions with a protrusion having the same size present on the surface of the magnetic disk because of the difference between the flying heights. Therefore, the outer-peripheral rail is deteriorated in protrusion detection sensitivity. Moreover, in the case of a two-rail glide head, it is not easy to distinguish between a detected impulse generated when the outer-peripheral rail collides with a protrusion and a detected impulse generated when the inner-peripheral rail collides with a protrusion and it is difficult to detect an accurate location of a protrusion. Therefore, a glide head in which lengths of rails are changed is disclosed in U.S. Pat. No. 5,963,396. As shown in FIG. 7, the U.S. patent proposes a glide head having a two-rail-shaped slider 70 in which the trailing end of a rail 75 located at the outer-peripheral side of a magnetic disk is made longer than that of a rail 76 located at the inner peripheral side on an air-bearing surface 71. While the glide head flies on the magnetic disk, the trailing end or edge has the smallest flying height. By making the trailing edge 75b of the outer-peripheral rail 75 of the magnetic disk longer than that of the inner-peripheral rail 76, the flying height of the trailing edge 75b of the outer-peripheral rail 75 is minimized. Therefore, the tail of the trailing edge 75 first collides with a protrusion. Thereby, the problem can be solved that it is difficult to detect an accurate location of a protrusion. In FIGS. 7 and 8, common components are provided with common symbols.

Increase of a recent magnetic disk drive in capacity and decrease of the drive in size, that is, increase of the drive in recording density is violently progressed. To improve a recording density, a recording bit is further decreased in size and thereby, the size of a magnetic head and the length of a magnetic gap are further decreased. Moreover, the gap between a magnetic disk and a magnetic head, that is, the flying height of a magnetic head slider is minimized up to 100 nm or less. When a magnetic head slider flies on a magnetic disk to record and reproduce information, if any asperity, protrusion, or contaminant larger than the flying height of the magnetic head slider is present on the surface of the magnetic disk, the slider collides with the magnetic disk and thereby, information cannot be accurately recorded or reproduced. They cause data or a hard disk drive to be broken. Therefore, it is necessary to make asperities, protrusions, and contaminants on the surface of a magnetic disk smaller than the flying height of a magnetic head slider. As the flying height of a slider is minimized, asperities, protrusions and contaminants on a magnetic disk specified in a specification tend to become smaller and the standard size of them is specified as 50 nm or less. Therefore, a glide head for inspecting a magnetic disk is necessary to have a smaller flying height.

To decrease the flying height of a conventional two-rail glide head, it is effective to decrease the widths of rails for producing a floating force. In the case of the two-rail glide head, however, the rails producing the floating force also serve as a portion for detecting protrusions on the surface of a magnetic disk. The whole surface of a magnetic disk is inspected while moving a glide head in the radius direction of a magnetic disk by every rail width. An area that can be inspected by a glide head at a certain location on radius is decided by a sensitive rail width. Therefore, when the width of a sensitive rail decreases, an area that can be inspected decreases and an inspection takes longer time.

Moreover, a glide head, as described in connection with its operation principle, detects the impulse when a rail collides with an asperity, protrusion, or contaminant and inspects asperities, protrusions, and contaminants on the magnetic disk. During inspecting the magnetic disk, the glide head repeatedly collides with an asperity, protrusion, or contaminant on the surface of the magnetic disk. When the glide head flies on the magnetic disk, the trailing edge of a rail of the glide head becomes the lowest point of the flying height of the glide head. However, it is difficult for the glide head to keep its flying attitude parallel with the surface of the magnetic disk due to its constitution and therefore, the head tends to fly with a tilt from the radius direction of the magnetic disk or it tends to roll. In this case, an internal corner at the trailing edge of a rail becomes the lowest point of the flying height of the glide head. Thus, when the glide head inspects the magnetic disk while flying with a tilt, not the whole trailing edge of a rail but only a corner of the trailing edge collides with an asperity, protrusion, or contaminant. When inspection is repeatedly executed under the above state, only a corner is intensively abraded and thereby, it is impossible to detect an accurate height of an asperity, protrusion, or contaminant. It is necessary to replace the intensively abraded glide head with a new one. Therefore, a glide head has a problem that its service life is shortened because one corner at the trailing edge of a rail is intensively abraded.

### SUMMARY OF THE INVENTION

Therefore, it is an object of the present invention to provide a small-flying-height glide head suited to inspect asperities, protrusions, and contaminants on a high-recording-density magnetic disk.

It is another object of the present invention to provide a glide head having a large-width sensitive rail.

It is still another object of the present invention to provide a glide head in which an end corner of a sensitive rail is not intensively abraded.

A glide head of the present invention has a leading end, a trailing end, and an air-bearing surface on a slider. The glide head has two substantially parallel rails on the air-bearing surface and a sensitive rail separate from the substantially parallel rails. The two substantially parallel rails protrude downward from the air-bearing surface, leading ends of the rails are located adjacent the leading end of the glide head, and trailing ends of the rails are directed toward the trailing end of the glide head. These two substantially parallel rails serve as floating rails. The sensitive rail protrudes downward from the air-bearing surface, the leading end of the sensitive rail is present at the trailing end of the glide head rather than trailing ends of the two substantially parallel rails and the trailing end of the sensitive rail is located adjacent the trailing end of the glide head. A transducer is mounted on the glide head to convert into an electrical signal the mechanical energy produced when a sensitive rail encounters a defect (asperity, protrusion, or contaminant) on a magnetic disk.

The two substantially parallel rails can have tapered faces on their faces opposite to the magnetic disk from their leading ends. Or, the air-bearing surface can have a bank protruded downward from the bearing surface and extended in the lateral direction adjacent the leading end of the glide head. The height of the lateral bank from the air-bearing surface is smaller than the height of leading ends of the two substantially parallel rails from the air-bearing surface. The lateral bank connects the leading ends of the two substantially parallel rails each other and forms a recess whose three sides are enclosed by the bank and two substantially parallel rails on the air-bearing surface.

It is preferable that the area of the sensitive rail is the half of or less than the total are of the two substantially parallel rails and more preferable that the area of the sensitive rail is 30% or less of the total area of them. It is preferable that the sensitive rail is wider than the trailing end width of each of the two substantially parallel rails. It is preferable that the sensitive rail is wider than a half of the width of the glide head.

It is preferable that the sensitive rail has a length smaller than its width and the leading end surface of the rail is tapered from the center toward the both side ends. It is preferable that the both side surfaces of the sensitive rail form round surfaces and corners are rounded.

### BRIEF DESCRIPTION OF THE DRAWINGS

FIG. 1 is a perspective view of a glide head of an embodiment of the present invention viewed from the bottom of the head;

FIGS. 2A to 2C show a glide head of another embodiment of the present invention, in which FIG. 2A is a bottom plan view of the glide head, FIG. 2B is a side view of the glide head, and FIG. 2C is a back view of the glide head;

FIGS. 3A to 3C show a glide head of still another embodiment of the present invention, in which FIG. 3A is a bottom plan view of the glide head, FIG. 3B is a side view of the glide head, and FIG. 3C is a back view of the glide head;

FIGS. 4 through 6 are bottom plan views of still another modifications of a glide head of the present invention;

FIGS. 7A to 7C show a glide head disclosed in a U.S. patent referred to in the present patent specification, in which FIG. 7A is a bottom plan view of the glide head, FIG. 7B is a side view of the glide head, and FIG. 7C is a front view of the glide head; and

FIG. 8 is a side view of a glide head for explaining it.

### DETAILED DESCRIPTION OF THE PREFERRED EMBODIMENTS

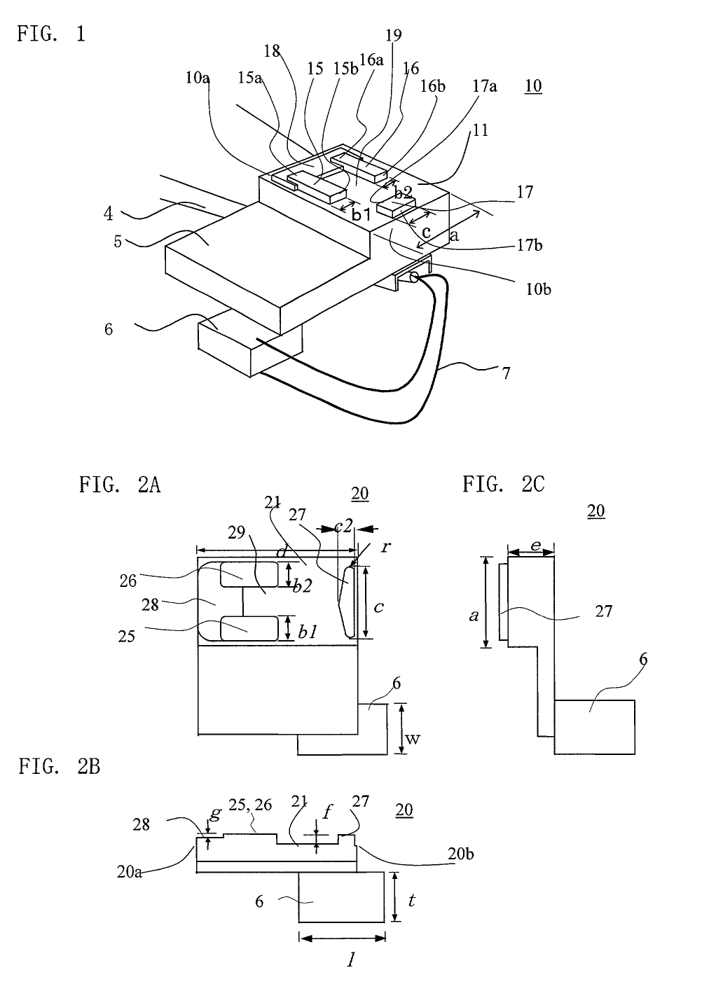

A glide head of the present invention is described below in detail, referring to the accompanying drawings. FIG. 1 is a perspective view of a glide head viewed from the bottom of the head. The glide head comprises a slider 10 and a lateral shelf 5 protruded from the side of the slider. The shelf 5 is also referred to as a wing. The upper surface of the slider and that of the lateral shelf constitute the back of the glide head. The slider 10 of the glide head has an air-bearing surface 11 at its lower surface (upper surface in FIG. 1), two substantially parallel floating rails 15 and 16 are provided for the air-bearing surface 11, and the two substantially parallel floating rails are arranged in the travelling direction of the glide head relative to a magnetic disk. The two substantially parallel rails 15 and 16 have its leading ends 15a and 16a adjacent the leading end 10a of the glide head and its trailing ends 15b and 16b are directed toward the trailing end 10b of the glide head and positioned at about the middle between the leading end 10a and trailing end 10b of the glide head. The glide head has a sensitive rail 17 adjacent its trailing end 10b on the air-bearing surface 11, the leading end 17a of the sensitive rail is located further in the direction of the trailing end 10b of the glide head than the trailing ends 15b and 16b of the two substantially parallel rails, and the trailing end 17b of the sensitive rail is located adjacent the trailing end 10b of the glide head.

Moreover, the glide head has a laterally extending bank 18 protruding downward from the air-bearing surface adjacent the leading end 10a of the glide head. The lateral bank 18 is lower in height than the leading ends of the two substantially parallel rails and connects the leading ends 15a and 16a of the two rails. The two substantially parallel rails 15 and 16 and the lateral bank 18 form an area 19 whose three sides are enclosed on the air-bearing surface and the area 19 serves as a recess.

FIG. 1 shows widths of the two substantially parallel rails 15 and 16 as b1 and b2 and the width of the sensitive rail 17 as c, and the width of the slider as a. In the case of a glide head of the present invention, the width c of the sensitive rail 17 is made larger than the widths b1 and b2 of the rails 15 and 16 but made smaller than the width a of the slider.

It is preferable to keep the area of the sensitive rail 17 (area of the surface parallel to the air-bearing surface) smaller than areas of the two substantially parallel rails 15 and 16 (areas of surfaces parallel to the air-bearing surface). The glide head is supported by a suspension 4 at its back and pressed against a magnetic disk to be inspected at a predetermined pressure. By rotating the magnetic disk about its spindle, air is supplied to the air-bearing surface of the glide head to fly the glide head from the surface of the magnetic disk. Because the force for floating the two substantially parallel rails 15 and 16 is larger than the floating force for the sensitive rail 17, the leading end 10a of the glide head is raised higher than the trailing end 10b and the sensitive rail 17 becomes closest to the surface of the magnetic disk to detect asperities, protrusions, and contaminants on the surface of the magnetic disk.

A transducer 6 or a piezoelectric device is mounted on the upper surface of the lateral shelf 5 formed on the side of the slider so that an output of the transducer 6 is taken out to the outside of the glide head through a pair of leads 7. When an asperity, protrusion, or contaminant contacts the sensitive rail, it vibrates the glide head. Therefore, the mechanical energy of vibration of the head is converted into an electrical signal by the transducer and taken out to the outside.

Trailing ends 15b and 16b of the two substantially parallel rails 15 and 16 are located at about the middle between the leading end 10a and trailing end 10b of the air-bearing surface 11. Because the pressure of the air flow passing along the surfaces of the parallel rails is lowered behind the trailing ends of the rails 15 and 16 and because the air flow whirls at the portion, the air flow also attracts the air-bearing surface 11 to lower the trailing end 10b of the glide head.

The lateral bank 18 and two substantially parallel rails 15 and 16 form the area 19 whose three sides are enclosed on the air-bearing surface. By slightly tapering the surface of the lateral bank 18, the glide head is floated by the lateral bank 18 at the leading end 10a of the glide head and the air flow passing along the surface of the lateral bank works so as to float the two substantially parallel rails 15 and 16. Because the air flow passing along the surface of the lateral bank and reaching the recess 19 between the two substantially parallel rails works as an attraction force, it increases the slope of the glide head.

FIGS. 2A to 2C show a glide head of another embodiment of the present invention, in which FIG. 2A is a bottom plan view of the glide head, FIG. 2B is a side view of the glide head viewed from the slider width direction, and FIG. 2C is a back view of the glide head viewed from the slider length direction. The slider 20 of this embodiment has a sensitive rail 27, two rails 25 and 26 contributing to floating, a shallow lateral bank surface 28, and a deep recess 29 for engulfing an air flow on its air-bearing surface 21. This configuration is the same as that of the embodiment in FIG. 1. In this case, however, the width c of the sensitive rail 27 is set to the half of the slider width a or more. The length c2 of the sensitive rail is set to ⅛ the width c. The direction of the slider length c2 is measured in the slider traveling direction. The slider 20 is formed into a rectangular parallelepiped, the slider length d is set to 1.2 mm, the slider thickness e is set to 0.4 mm, and the slider width a is set to 0.9 mm. The leading end of the sensitive rail 27 is tapered from the center toward the both side ends and the rail width c is set to 0.8 mm. The area S₂ of the sensitive rail is set to approx. 25% of the sum S₁ of areas of the two floating rails 25 and 26. Moreover, both side end surfaces of the sensitive rail are rounded so that corners respectively have a radius of curvature of 0.015 mm. Moreover, the width b₁ of a rail (outside-rail width) and the width b₂ of a rail (inside-rail width) contributing to floating are set to 0.19 and 0.20 mm, respectively. Furthermore, the depth f of the recess 29 (height from the air-bearing surface up to a floating-rail surface) formed at the central portion of the air-bearing surface 21 is set to 2.0 μm and the depth g of the lateral bank surface 28 formed at the leading end from the floating-rail surface is set to 0.2 μm.

In this case, by tapering the leading end of the sensitive rail from the center toward the both side ends, a part of the air flow coming along the air-bearing surface may detour along the diagonal leading end instead of running on the surface of the sensitive rail 27 and works so as to suppress the floating of the sensitive rail.

In the case of the slider in FIG. 2, the shape of the air-bearing surface is formed through physical etching. The process is described below. First, photoresist is applied onto a slider substrate (alumina-titanium carbide ceramics) to expose and develop the photoresist and then, the photoresist is removed while leaving portions on which the sensitive rail 27 and floating rails 25 and 26 will be formed to form a resist mask. Then, milling is performed by an ion milling machine to grind portions other than the resist mask up to a depth equivalent to the depth (shallow step) from the floating rails 25 and 26 on the lateral bank surface 28. Then, photoresist is applied onto the substrate again to expose and develop the photoresist, leave the photoresist at portions corresponding to the sensitive rail 27, floating rails 25 and 26, and lateral bank surface 28, and then the photoresist at other portions is removed to form a resist mask. Milling is performed again to grind portions not covered with the resist mask. The depth of a portion to which milling is applied twice is equalized with the depth of the air-bearing surface 21 (deep step surface 29). An air-bearing surface is formed in the above process. Then, the lateral shelf of the slider is formed and a piezoelectric device 6 having a width w=0.5 mm, a length l=0.9 mm, and a thickness t=0.8 mm is mounted on the shelf.

Though not illustrated, a suspension same as that in FIG. 1 is set to the slider to form a glide head in FIG. 2. By using the glide head, it is possible to inspect a magnetic disk in a shorter time in accordance with a specification of the magnetic disk in which heights of an asperity, protrusion, and contaminant are decreased. A glide head having a conventional structure is used for the specification in which heights of an asperity, protrusion, and contaminant are specified as 50 nm or less. However, the glide head of this embodiment can be applied to the case in which heights of an asperity, protrusion, and contaminant are specified as 10 to 20 nm. Moreover, the end of a rail of this embodiment is less intensively abraded compared to the abrasion of a rail of a conventional glide head. Therefore, it was possible to use the rail for a longer time. By using the configuration of this embodiment, the service life of a glide head became approx. 1.5 times larger than that of a conventional configuration.

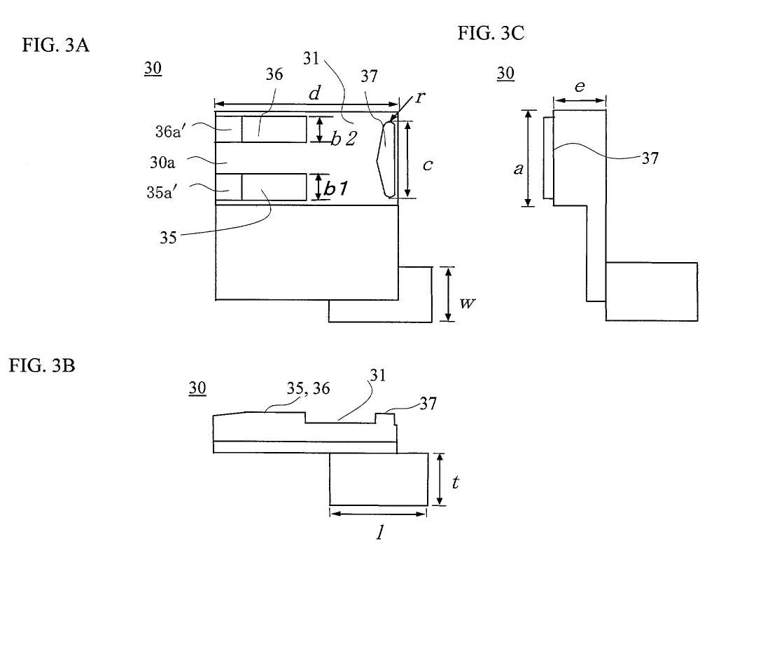

FIGS. 3A to 3C show a glide head 30 of still another embodiment, in which FIG. 3A is a bottom plan view of the glide head 30, FIG. 3B is a side view of the glide head 30 viewed from the slider width direction, and FIG. 3C is a back view viewed from the slider length direction. Though the general configuration of this embodiment is the same as that of the embodiment in FIG. 2, the configuration of the slider air-bearing surface of this embodiment is different from that of the embodiment in FIG. 2. A slider 30 has a sensitive rail 37 and two floating rails 35 and 36 on an air-bearing surface 31, beveled tapers 35a′ and 36a′ are formed at leading ends of the floating rails, and the air-bearing surface 31 is flat up to its leading end 30a but it does not have a lateral bank. In the case of the slider 30, the length d is set to 1.2 mm, the thickness e is set to 0.4 mm, and the width e is set to 0.9 mm. The sensing-rail width c is set to 0.8 mm so as to become the half of or more than the slider width a. Moreover, a radius of curvature of 0.015 mm is provided for the side end of the sensitive rail. The widths b₁ (outside-rail width) and b₂ (inside-rail width) of the floating rails are set to 0.19 mm and 0.2 mm. This embodiment is different from the configuration in FIG. 2 in that beveled tapers 35a′ and 36a′ for supplying air flow to surfaces of the floating rails from the leading end are formed instead of a shallow step surface. As a result of inspecting a magnetic disk by using the glide head with the above configuration, the same effect as the case of the embodiment in FIG. 2 was confirmed.

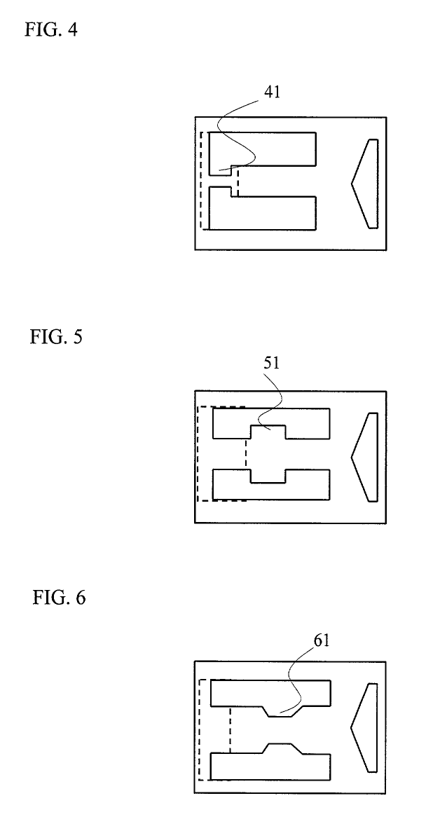

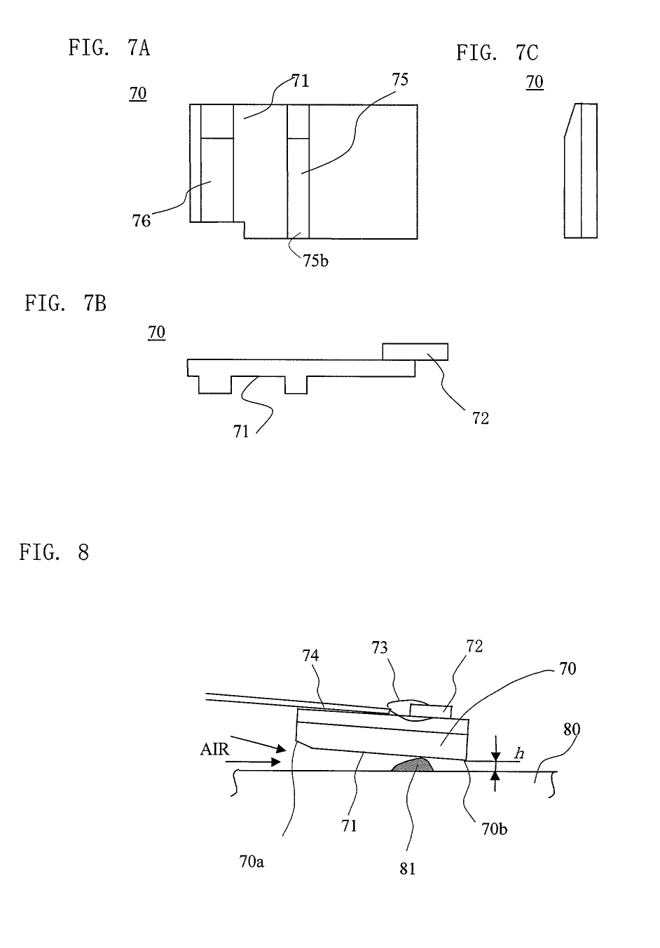

In the description of the embodiment shown in FIGS. 1 through 3, the floating rails 15, 16, 25, 26, 35, and 36 are referred to as “substantially parallel rails”. This represents that a pair of rails are extended in substantially parallel. These rails can respectively have side protrusions 41 and 61 or a side recess 51 at their side surfaces like modifications of the present invention shown by bottom plan views in FIGS. 4 to 6.

What is claimed is:

1. A glide head for detecting defects on a magnetic disk, the glide head having a leading end, a trailing end and an air bearing surface, the glide head comprising:
two substantially parallel rails protruding downwardly from the air bearing surface, each of the two substantially parallel rails having a leading end located adjacent the leading end of the glide head and a trailing end directed toward the trailing end of the glide head;
a sensitive rail separated from the two substantially parallel rails and protruding downwardly from the air bearing surface, the sensitive rail having a leading end located further in the direction of the trailing end of the glide head than the trailing ends of the two substantially parallel rails and a trailing end located adjacent the trailing end of the glide head; and
a transducer mounted on the glide head, the transducer converting a mechanical energy into an electrical signal when the sensitive rail encounters a defect on a magnetic disk.

2. A glide head as set forth in claim 1, wherein the area of the sensitive rail is less than a half of the sum of the areas of the two substantially parallel rails.

3. A glide head as set forth in claim 1, further comprising a laterally extending bank protruding downwardly from the air bearing surface, the bank being lower than the leading ends of the two substantially parallel rails and traversing between the leading ends of the two substantially parallel rails to form a recess on the air bearing surface surrounded with the two substantially parallel rails and the bank on three sides of the recess.

4. A glide head as set forth in claim 1, wherein the sensitive rail is wider than the trailing end width of each of the two substantially parallel rails.

5. A glide head as set forth in claim 4, wherein the sensitive rail is wider than a half of the width of the glide head.

6. A glide head as set forth in claim 1, wherein the length of the sensitive rail is less than the width thereof, and the leading end surface of the sensitive rail is tapered from the center of the leading end surface to both side surfaces of the sensitive rail.

7. A glide head as set forth in claim 6, wherein both the side surfaces of the sensitive rail are rounded.
